(19) United States
(12) Patent Application Publication
(10) Pub. No.: US 2023/0334898 A1
(43) Pub. Date: Oct. 19, 2023

(54) Electronic Device Comprising a Biometric Optical Sensor Module

(71) Applicants: Wave Touch Denmark A/S, Taastrup (DK); Wave Touch Limited, Hong Kong (CN)

(72) Inventors: Weiqi Xue, Taastrup (DK); Peng Xiang, Hong Kong (CN); Jørgen Korsgaard Jensen, Taastrup (DK)

(21) Appl. No.: 18/003,085

(22) PCT Filed: Jun. 24, 2021
(86) PCT No.: PCT/EP2021/067388

§ 371 Date: Dec. 22, 2022

(30) Foreign Application Priority Data
Jun. 24, 2020 (EP) 20182048.7

(51) Int. Cl. G06V 40/12; G06V 40/13

(52) U.S. Cl. CPC G06V 40/1394; G06V 40/1318

(57) ABSTRACT

The present disclosure relates to an electronic display device for detecting and validating an object by optical sensing, comprising a display panel having light emitting pixels to display images, a top transparent surface formed over the display panel as an interface for being touched by a user for touch sensing operations, an optical sensor module located under the display panel or It integrated in the display panel comprising a sensor array of optical detector pixels configured for 1) receiving light reflected from the object on the surface of the display panel, and 2) generating image data according to the received light. The electronic device is configured to controlling pixels of the display panel to provide light in a predefined first illumination pattern towards the object on the surface of the display panel, directing light reflected from the object on the surface of the display panel to the sensor array within a predefined acceptance angle, acquiring, with the sensor array, first image data based on light reflected from a first part the object which is only illuminated with light from the predefined first illumination pattern from which the specular reflections by the surface of the display panel is outside the predefined acceptance angle, and analysing intensities at different wavelengths in said first image data to validate the object.

The present disclosure relates to an electronic display device, having an optical sensor module, for detecting and validating an object on a touch surface of the electronic device, in particular an object such as a finger. The present disclosure further relates to a biometric optical sensor system for detecting and validating an object on a touch surface of a display panel.

### BACKGROUND

Biometric systems, e.g. in the form of fingerprint sensors, have been massively integrated in electronic devices with displays, such as smartphones, tablets, laptops, for privacy and data protection, as well as identity authentication. Today the most common fingerprint sensor is a capacitive sensor that works independent from the display of the device. The present move towards displays covering almost the entire front of the device makes it difficult to integrate the biometric imaging module with the front surface because the capacitive sensors are not easily integrated with the electronics displays

Optical biometric sensors can be placed beneath the cover glass of the displays, because reflections from a finger can be scattered back through the cover glass and displayed to the biometric sensor. Examples of such biometric sensor systems are microlens based sensor systems, pinhole based sensor systems and camera type sensor systems. One example of a microlens based under-display biometric sensor is disclosed in pending application PCT/EP2019/061738 from the same applicant, wherein an array of microlenses is provided in combination with an opaque layer with an array of apertures/pinholes and a sensor array such that light can be focused by the microlens structure onto the sensor array through the apertures.

PCT/EP2019/061738 is hereby incorporated by reference in its entirety. A pinhole type biometric sensor is exemplified in WO 2017/211152. Both pinhole-type and microlens-type sensors can be seen as telecentric-like systems (at the object side) with a predefined acceptance angle of the reflected light. The acceptance angle is the same for the entire sensor array and the view-angle of the sensor system is typically 0 degree. A camera-type under-display biometric sensor comprises a single camera with optics defining a field of view of the entire biometric surface, i.e. the view-angle of the camera is changing for different locations on the biometric surface. The acceptance angle of a camera type sensor system will therefore be varying across different areas of the biometric surface.

But biometric sensors are facing the challenge that a fake object, e.g. a fake fingertip, may easily fool the sensors. A molded or 3D printed fingertip, e.g. from silicone, plastic or rubber, can fool under-display/in-display fingerprint sensors integrated in present smartphones or tablets, because the fingerprint validation in fingerprint sensors rely on the difference in the direct specular reflections from valleys and ridges in the fingerprint surface structure on the air-glass interface on the cover glass surface of the display panel, a reflectance pattern that can be imitated by fake fingerprints.

### SUMMARY

Reflectance spectroscopy is a well-known technology that can be utilized to distinguish between different materials and it has previously been deployed for addressing the issue of live tissue recognition in table-top fingerprint scanners. But as under-display and in-display fingerprint sensors typically utilizes the light emitting pixels of the display panel directly below the fingerprint, the captured fingerprint structures are generated mainly by the direct reflections from the air-glass interface on top of the display panel, received within an acceptance angle of the sensors, i.e. they are not carrying any information about the skin itself. A direct implementation of reflectance spectroscopy in under-display and in display biometric optical sensors is therefore impossible. Plus, the space in under-display and in display applications is very limited. Hitherto known solutions for spoof detection of fingerprints, exemplified in Pishva et al, “Spectroscopically Enhanced Method and System for Multi-Factor Biometric Authentication,” IEICE Transactions on Information and Systems, 2008, Volume E91.D, Pages 1369-1379, are not suitable for incorporation in under-display or in-display biometric optical sensors. One purpose of the present disclosure is therefore to integrate spoof detection in under-display and in-display biometric optical sensor systems.

The present inventors have realized that by carefully controlling the pixels of the display panel, light emittance towards the top surface of the display panel can be controlled accordingly, whereby live tissue recognition/spoof detection of an object deploying reflectance spectroscopy can be implemented in current under-display and in-display biometric optical sensor modules for electronic display devices. The general idea is that an illumination pattern is created using the display pixels ensuring multi-wavelength illumination for spectroscopic analysis. E.g. in case of an OLED display, the RGB display pixels can ensure red, green and blue light, i.e. multi-wavelength illumination, with RGB light in the form of multiple discrete wavelengths. The illumination pattern can be designed such that part of the object is only illuminated with light with an illumination incidence angle which is larger than the acceptance angle of the sensor module. In this way, the reflection from the glass interface can be removed from the detection. Hence, live tissue recognition can be provided deploying reflectance spectroscopy by analyzing the areas of the sensor array which is only illuminated with light from the illumination pattern from which the specular reflections by the surface of the display panel is outside the acceptance angle of the sensor module.

A first embodiment of the present disclosure relates to an electronic device for detecting and validating an object by optical sensing, comprising a display panel having pixels to display images, a top transparent surface formed over the display panel as an interface for being touched by a user for touch sensing operations, and an optical sensor module located under the display panel or integrated in the display panel. An electronic device such as a mobile communication unit, a computing device, a display device, etc., such as a smartphone, or tablet, PC, camera device, touch screen device, or the like.

The optical sensor module is preferably an optical sensor module for biometric optical sensing, e.g. fingerprint detection, and preferably the sensor module comprises a sensor array of optical detector pixels configured for receiving light reflected from the object on the surface of the display panel, and generating image data according to the received light.

The electronic device and/or the optical sensor module may be configured to emit multi-wavelength light in a predefined first illumination pattern towards the object on the surface of the display panel, e.g. during touch sensing operation, for example by controlling pixels of the display panel to provide light in a predefined first illumination pattern towards the object on the surface of the display panel.

The electronic device and/or the optical sensor module may further be configured for directing light reflected from the object on the surface of the display panel to the sensor array, preferably within a predefined acceptance angle.

Further, the electronic device and/or the optical sensor module may be configured for acquiring, with the sensor array of the optical sensor module, first image data based on light reflected from a first part the object which is only illuminated with light from the predefined first illumination pattern from which the specular reflections by the surface of the display panel is outside the predefined acceptance angle

Reflectance spectroscopy can be provided by analysing intensities at different wavelengths in said first image data to validate the object.

The present inventors have realized that a typical display panel, e.g. an OLED display panel, has light emitting pixels in different colour, typically Red, Green and Blue (RGB), i.e. a multi-wavelength light source is right at hand for reflectance spectroscopy.

The present inventors have also realized that in order to carry information about the object itself, e.g. information about the material of the skin of a finger, one must avoid the specular reflections from the air-glass interface on the surface of the display panel, because the specular reflections are not carrying any spectroscopic information about the material of the object. But as the in-display and under-display biometric optical sensors typically has a certain acceptance angle for receiving the reflected light, the inventors have realized that an illumination pattern must be created that takes account of the specular reflections from the surface, the acceptance angle of the optical setup and utilizes the wavelength variation in the light emitting pixels of the display panel in order to extract the necessary spectroscopic information.

A multi-wavelength illumination pattern can for example be created by controlling which colour of pixels within each RGB pixel to turn on and by measuring the corresponding intensity from the reflected signal, the user's skin colour can for example be determined, e.g. if the object is a finger. (In case of chromatic pixels in the sensor, the colour segmentation can be provided in the sensor array and all colour RGB pixels and be utilized simultaneously.) As an example, when a user registers a finger for fingerprint authentication operation, the biometric optical sensor also measures intensities of the scatter light from finger at, at least, two different colours or wavelengths A and B, as measured intensities I_{A} and I_{B}, respectively. The ratio of I_{A}/I_{B} can then be stored to compare with later measurements when the user's finger is placed on the sensing area to measure the fingerprint, such that the fingerprint can be further validated. I.e. the traditional fingerprint structure may be accepted, but if the fingerprint is not live tissue the spectroscopic data will vary, e.g. if the I_{A}/I_{B} reference does not match, and the fingerprint is hence not spectroscopically validated, i.e. spoof detection is provided.

The general idea does not necessarily require any structural modifications of current biometric optical sensors because the novel aspects, i.e. the illumination pattern, the light acquisition, the data analysis and the object validation, can be implemented in software.

The light source control and/or the data/image analysis can be provided by a processing unit of the electronic device and/or by a processing unit of the optical sensor module.

A further embodiment relates to a biometric optical sensor system for detecting and validating an object on the surface of a display panel having light emitting pixels, the optical sensor system comprising
a sensor array of optical detector pixels, for placement under the display panel or integrated in the display panel, configured for
a) receiving light reflected from the object on the surface of the display panel, and
b) generating image data according to the received light,

wherein the optical sensor system is configured to:
utilizing pixels of the display panel to control light in a predefined first illumination pattern towards the object on the surface of the display panel,
directing light reflected from the object on the surface of the display panel to the sensor array within a predefined acceptance angle,
acquiring, with the sensor array, first image data based on light reflected from a first part the object which is only illuminated with light from the predefined first illumination pattern from which the specular reflections by the surface of the display panel is outside the predefined acceptance angle, and
analysing intensities at different wavelengths in said first image data to validate the object.

I.e. the presently disclosed biometric optical sensor can be implemented as almost a standalone system for integration in an electronic display device with internal data processing of object imaging and/or object validation and where the pixels of the display panel are controlled and/or utilized as at least a part of the illumination light source. However, the preferred embodiment is as a biometric optical sensor module for integration in an electronic display device and wherein the control of the light source, image data processing and object validation is provided by one or more processing units of the electronic display device.

### DESCRIPTION OF THE DRAWINGS

The invention will in the following be described in greater detail with reference to the accompanying drawings:

FIG. 1 illustrates the traditional way of generating a fingerprint image: The “valleys” and “ridges” in the surface of a fingertip create different reflections.

FIG. 2 shows the reflectance spectra from the right index finger from five different subjects.

FIG. 3 exemplifies the presently disclosed principle of avoiding specular reflections when performing reflectance spectroscopy.

FIG. 4 shows a cross-sectional exemplary illustration of an under-display/in-display microlens or pinhole type biometric optical sensor in normal operation mode.

FIG. 5 shows a cross-sectional exemplary illustration of an under-display/in-display microlens or pinhole type biometric optical sensor where a subset of the light emitting display pixels directly illuminate part of the finger and indirectly illuminate an adjacent part of the finger.

FIG. 6 shows a cross-sectional exemplary illustration of an under-display camera type biometric optical sensor.

FIG. 7 shows an example of an illumination pattern illustrated as one central dark spot in the sensing area.

FIG. 8 shows an example of an illumination pattern illustrated as five dark spots in the sensing area.

FIG. 9 shows an example of an illumination pattern illustrated as a dark cross in the sensing area.

FIG. 10 shows an example of an illumination pattern illustrated as one central light spot in the sensing area.

FIG. 11 shows a cross-sectional illustration of a microlens type under-display biometric optical sensor.

FIG. 12 shows a cross-sectional exemplary illustration of an electronic device according to the present disclosure with a LCD panel and a biometric optical sensor with IR light source(s) located below the LCD panel for under-display biometric sensor applications.

### DETAILED DESCRIPTION

For pinhole type sensors and microlens type sensors that acceptance angle of the optical setup is typically fixed for all viewing angles. In one embodiment the predefined acceptance angle of the biometric optical sensor is 20 degrees or 10 degrees or 5 degrees or 3 degrees. For pinhole type sensors and microlens type sensors the acceptance angle is normally around 3-5 degrees.

The optical detector pixels of the sensor array may be chromatic pixels for distinguishing different colors of the received light.

In one embodiment the pixels of the display panel are RGB light emitting pixels. This is for example the case in OLED type displays. Accordingly, the electronic device/the biometric optical sensor system, during touch sensing operation, may be configured for controlling RGB light emitting pixels of the display panel to emit RGB light in a predefined first illumination pattern towards the object on the surface of the display panel, such that multi-wavelength illumination light is ensured.

In case of a LCD (liquid crystal display) display panel two perpendicular polarizers together with a liquid crystal layer act as a light on/off switch for each display pixel by utilizing the polarization of the light, i.e. the emitted light is not generated by display pixels of a LCD panel, but light emittance is controlled by the display pixels of a LCD panel. It may be more challenging to effectuate the presently disclosed approach using the light from the pixels of the LCD display panel itself, because a reflector sheet is typically provided in the bottom of a LCD panel such that the RGB light from the display panel typically cannot reach an optical biometric sensor located below the display panel. However, one solution that can be utilized is a near infrared transmission system, e.g. 3M™ NITS, employing micro-thin optical display films to allow fingerprint-reading optical sensors to be placed behind an LCD screen utilizing special bottom reflector sheet and diffuser sheet to replace the normal reflector and diffuser sheets. These sheets can be configured such that for example infrared (IR) light can be transmitted through the whole LCD display without being much distorted, while visible RGB light can still be reflected upwards by the bottom reflector sheet. A further advantage is the basic on/off switch, i.e. two perpendicular polarizers and the liquid crystal structure, is maintained and can also be used to control the IR light coming, i.e. such that IR light emittance toward the top surface of the display panel can also be controlled by the individual pixels of the display panel. Thereby the presently disclosed illumination patterns can also be generated with a LCD display panel.

Hence, at least two probe light sources may be provided, such as LEDs or lasers, separate from the display panel, the probe light sources having at least two different wavelengths, e.g. at least two different IR wavelengths to ensure multi-wavelength illumination, because also in the infrared spectra there is sufficient spectral variation, and the intensity variation as a function of wavelength is also very stable in the infrared range, which can provide the basis for reflectance spectroscopy with an LCD display panel.

The electronic device may then be configured such that the pixels of the display panel control light emittance (towards the surface of the display panel) of said probe light sources to illuminate the object on the surface of the display panel. Thereby the light from the probe light sources become at least part of, or entirely form, the predefined first and/or second illumination patterns.

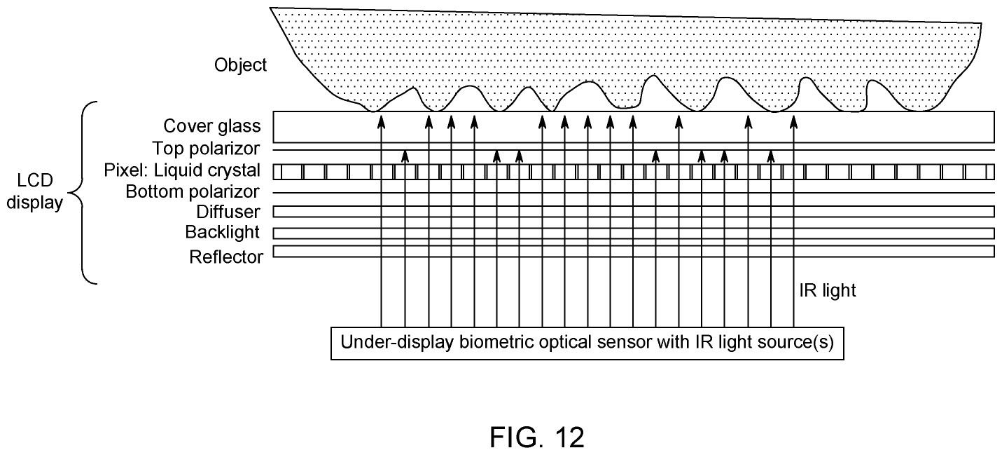

Incorporation of the presently disclosed approach in a LCD panel is illustrated in FIG. 12 showing a cross-sectional exemplary illustration of an electronic device according to the present disclosure with a LCD display and a biometric optical sensor with IR light source(s) located below the LCD panel for under-display biometric sensor applications. The LCD display comprises from the top a cover glass with a top surface forming the touch-sensitive area. A layer of liquid crystals forms the pixels and light emittance per pixel level is controlled by top and bottom polarizers above and below the liquid crystal layer. Diffuser, backlight and reflector layers are provided below the bottom polarizer. The under-display biometric sensor is located below the LCD display and is provided with one or more IR light sources to provide multi-wavelength IR illumination towards the top surface. All the layers of the LCD display are transparent to the IR light from the under-display biometric sensor, but the polarizer can still control emittance of the IR light coming from the biometric sensor on a per pixel level, such that IR illumination pattern(s) can be generated. The IR light reflected from the top surface can also be transmitted through the LCD display and be received by the biometric sensor to provide for spoof detection.

In order to perform “traditional”/“normal mode” object detection and imaging, a second illumination pattern can be generated. E.g. in the normal mode all pixels located directly underneath the sensing area and/or the object on the top surface, are turned on/activated and all reflections received within the acceptance angle will be captured and detected by the optical sensor. The received light includes both reflections from the glass interface and the object. I.e. in one embodiment the electronic device/optical sensor may be configured for:
controlling/utilizing the display panel to emit light in a predefined second illumination pattern towards the object on the surface of the display panel,
acquiring, with the sensor array, second image data based on light reflected from a second part the object which is illuminated with light from the predefined second illumination pattern, and
acquiring, with the sensor array, second image data comprising light reflected from the second part of the object, and
analysing the second image data to form an image of the object.

As also detailed below the second illumination pattern may be provided concurrently with the first illumination pattern, or before or after. They may also be equal, i.e. the first and second illumination pattern is the same single illumination pattern. Correspondingly the acquisition of the second image data can be provided before, concurrently or after the acquisition of the first image data, i.e. it might be a single acquisition of image data, for example if the first and second illumination patterns are provided concurrently.

Correspondingly the first image data and/or the second image data may correspond to at least one predefined and/or fixed subset of the sensor array.

In one embodiment the intensity at one wavelength in said first image data corresponds to processing all pixel values of a subset of the sensor array, processing such as averaging, integrating, and/or adding.

Background intensity calibration may be necessary—as for traditional object detection. Background intensity calibration may for example be provided during registration of a new object. Background intensity calibration may accordingly be provided by:
acquiring, with the sensor array, background image data corresponding to the first image data based on light reflected from only the surface (without an object on the surface) of the display panel, and received within said predefined acceptance angle, and
analysing intensities at said different wavelengths to determine a background intensity at each of said different wavelengths.

Object validation, i.e. spoof detection, can be provided by analysing the intensity variation (e.g. relative to a background intensity) as a function of the wavelength of the light and comparing it to a reference. The reference may for example be a reflectance spectral variation.

Alternatively the reference is provided one or more thresholds, such as one or more intensity ratio thresholds, such as one or more thresholds defining whether or not the object is live tissue. The reference may be obtained from objects of the same kind.

A reference for a specific object may be obtained during registration of said object by analysing intensities at said different wavelengths to determine a reference intensity variation for said specific object.

In one embodiment the predefined first and/or second illumination pattern corresponds to activation of one or more predefined subsets of the light emitting pixels. The location and configuration of the predefined and/or fixed (active) subset of the sensor array may accordingly be related to and/or defined by the predefined first and/or second illumination pattern.

Multi-wavelength illumination may be provided by broadband light and/or by means of multiple discrete wavelengths, such as at least two, three or more different discrete wavelengths, in the illumination pattern(s). E.g. red peaking near 564-580 nm, green peaking near 534-545 nm and blue peaking near 420-440 nm. In the infrared spectrum a broad wavelength range is also suitable for biometric sensing, for example around approx. 800-2000 nm with examples of discrete wavelengths at 850 nm, 980 nm, 1050 nm, 1300 nm and 1550 nm, where cost efficient lasers/LEDs are commercially available, between either of these discrete IR wavelengths a suitable wavelength gap for spectroscopic analysis, as herein described.

In one embodiment the predefined first and/or second illumination pattern is a predefined spatial illumination pattern. E.g. the first illumination pattern may form stripes on the object.

In one embodiment the predefined first and/or second illumination pattern is a predefined time-varying illumination pattern, for example such that the illuminated first and second parts of the object are identical or at least partly overlapping.

In one embodiment the predefined first and/or second illumination pattern is a predefined color varying illumination pattern.

In one embodiment the predefined first and second illumination patterns are emitted concurrently, such as wherein the first and second image data can be acquired concurrently.

In one embodiment the predefined first and second illumination patterns are emitted concurrently such that the first and second image data can be acquired concurrently.

In one embodiment the acceptance angle of the sensor array, the positioning of the optical detector pixels with respect to the top transparent surface and/or the first and/or second illumination pattern, is arranged such that the optical detector pixels receives light reflected and/or scattered from areas of the top transparent surface that do not overlap. I.e. each optical detector pixel of the sensor array is to receive light reflected from different areas of the top transparent surface and/or different areas of an object in contact with said top transparent surface. This may be achieved in several different ways, and may for example depend on the distance between the optical detection pixels, the distance between the optical detection pixel and top transparent surface, and/or the acceptance angle of the sensor array. In general, a larger acceptance angle requires a larger distance between the optical detection pixels and/or a smaller distance between the optical detection pixels and the top surface in order to avoid overlap between the light from the top surface (or the object in contact with said top surface) received by the different optical detection pixels.

The illumination angle of an OLED/LCD display is typically significantly high, not uncommonly above 75 degrees and/or may display a Lambertian distribution. In addition it is typical that multiple pixels of a display have to be turned on due to the low optical intensity. This may result in a point of an object, in contact with the top surface, being illuminated by light at different illumination angles. Depending on the arrangement of the sensor array, such as the density of the optical detection pixels (e.g. the distance between each pixel), the distance between the sensor array and the top surface, and the acceptance angle of the sensor array, the light illuminating the aforementioned point of an object, at different illumination angles, may be reflected/scattered and thereafter received by multiple optical detection pixels, i.e. the same point of the object may be imaged by multiple optical detection pixels. Contrary to this, in an embodiment, the electronic device is configured such that each optical detection pixel images a different area of the top transparent or an object in contact with said top transparent surface.

The type of the display panel may be selected from the group of: Electroluminescent (ELD) display, Liquid crystal display (LCD), Light-emitting diode (LED) display, such as OLED or AMOLED, Plasma (PDP) display, and Quantum dot (QLED) display.

The typical display panel has three distinct colours of the light emitting pixels: Red, green and blue. In order to provide additional spectral variance one or more additional probe light sources may be provided, either as part of the biometric optical sensor and/or as part of the electronic device. I.e. at least one probe light source, separate from the light sources of the display panel, such as an LED or laser, may be controlled to provide probe light to illuminate the object on the surface of the display panel, such that the light from the probe light source becomes part of the predefined first and/or second illumination pattern. Accordingly, the light from the probe light source comprises at least one color/wavelength which is different from the light from the display panel, such as infrared light. For example light from at least a first probe light source is of a color which is less than the light from the display panel, and/or light from at least a second probe light source is of a color which is larger than the light from the display panel.

One example of a microlens based under-display biometric sensor is disclosed in pending application PCT/EP2019/061738 from the same applicant. In one embodiment of the present disclosure the optical setup of the biometric optical sensor comprises
a microlens structure having a front side with an array of light focusing elements and an opaque back side with an array of optically transparent apertures aligned with the focusing elements, and
a sensor array of optical detector pixels facing the back side of the microlens structure, wherein each aperture is aligned with at least one of said optical detector pixels.

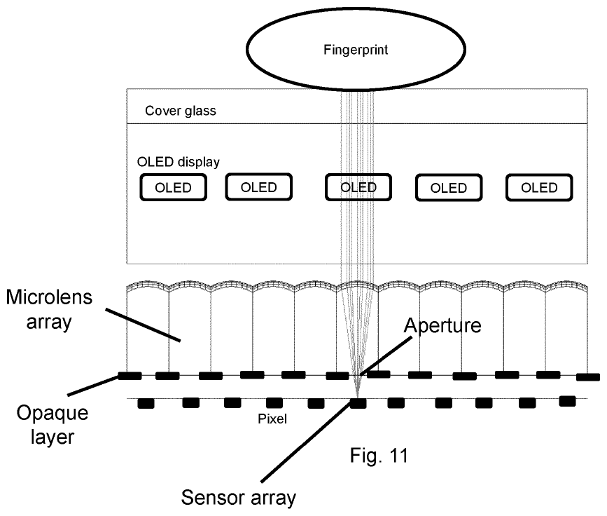

The optical sensor is preferably configured such that light returned from the object can be focused by the microlens structure onto the sensor array through the transparent apertures and such that light returned from the object with an incident angle of less than or equal to a predefined value is focused by the microlens structure to the sensor array whereas light returned from the object with an incident angle of more than said predefined value is not detected. I.e. this predefined value of the incident angle corresponds to the acceptance angle as used herein. One example of such an optical sensor is shown in a cross-sectional illustration in FIG. 11.

### EXAMPLES

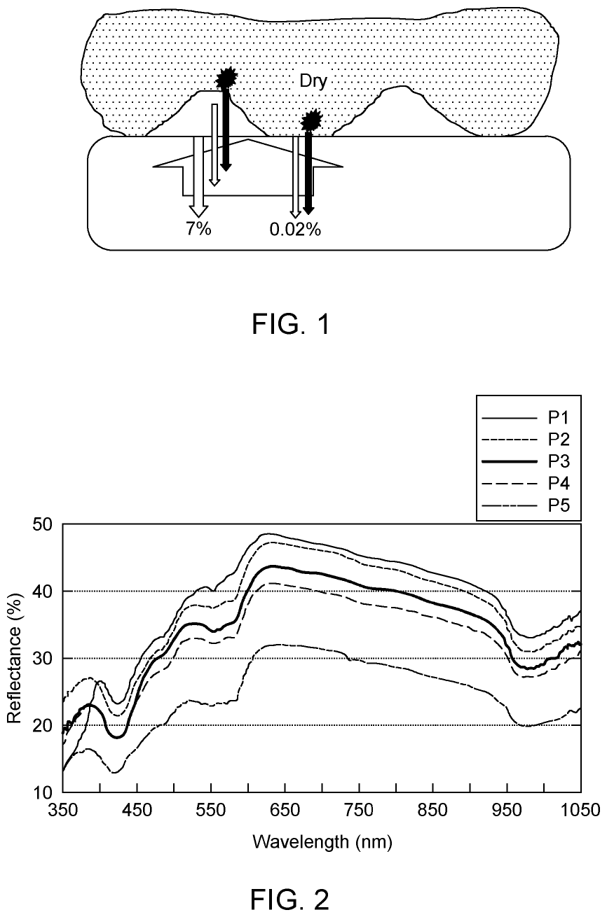

FIG. 1 illustrates the traditional way of generating a fingerprint image: The “valleys” and “ridges” in the surface of a fingertip creates different reflections; the valley areas generates a 7% reflection due to the air-glass interface, whereas the ridge areas, where the skin touches the surface” only generates a 0,02% reflection, i.e. it is quite straightforward to distinguish valleys and ridges to generate an image that clearly illustrates the unique fingerprint pattern.

FIG. 2 shows the reflectance spectra from the right index finger from five different subjects. Although absolute measured intensity varies much from subject to subject, the intensity variation as a function of wavelength is very stable, which provides the basis for reflectance spectroscopy.

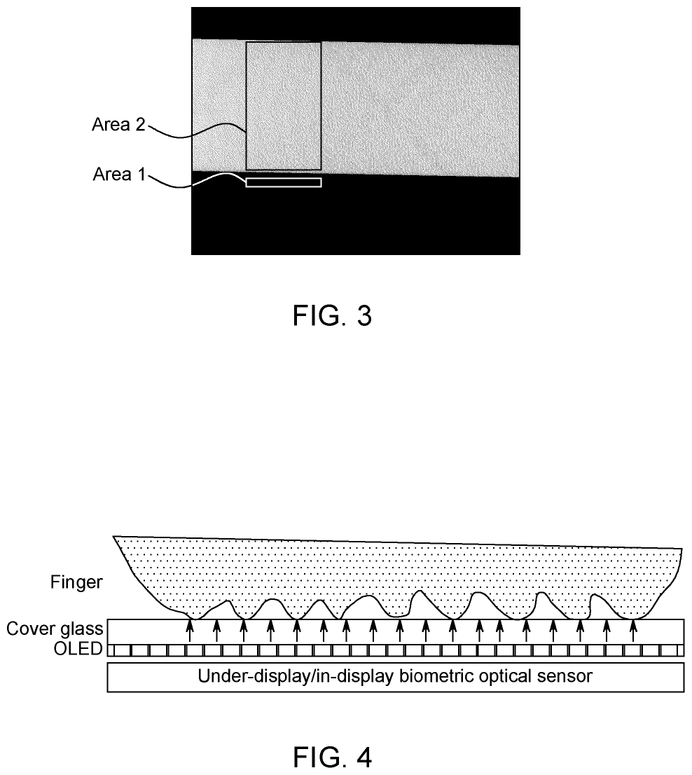

FIG. 3 illustrates the presently disclosed principle of avoiding specular reflections when performing reflectance spectroscopy. “Area 2” points to normal mode operation, where all corresponding display panels' pixels light up to directly illuminate the object, i.e. second image data as termed herein is acquired from the directly illuminated area where Area 2 belong. “Area 1” points to the adjacent dark area where light emitting pixels, which are located directly below, are turned off, but the object is still indirectly illuminated because neighboring pixels light up. Thereby the specular reflections from the direct illumination can be avoided and reflectance spectroscopy can be provided and first image data as termed herein may correspond to Area 1. In this example the first illumination pattern and the second illumination pattern are equal, because the illumination pattern shown in FIG. 3 can be used to both acquire the normal mode biometric image where the object is directly illuminated and where an image of the object is provided, and the spoof detection mode where a first part the object is only illuminated with light from the illumination pattern from which the specular reflections by the surface of the display panel is outside the predefined acceptance angle.

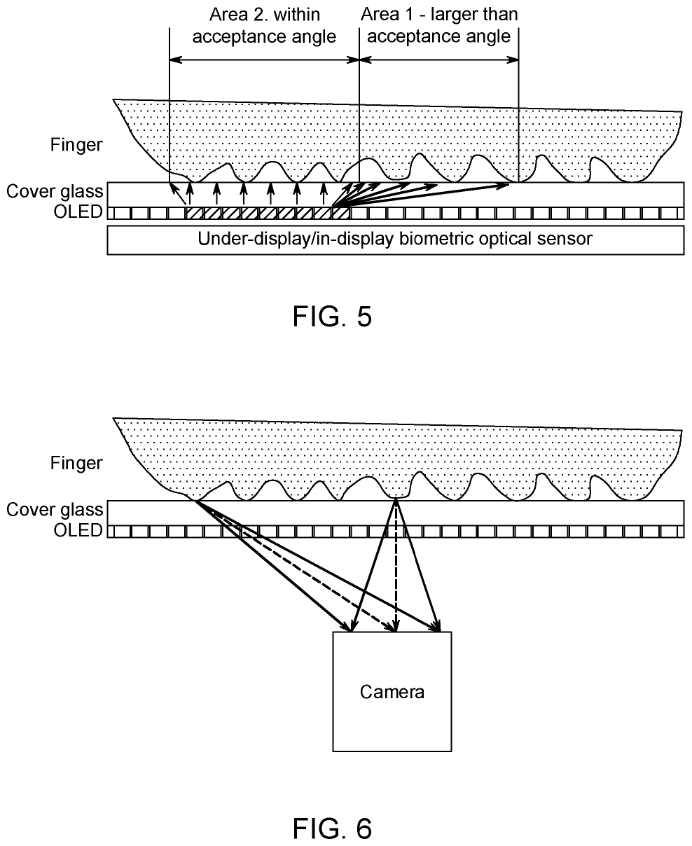

This is further illustrated in FIGS. 4-5 showing a cross-sectional exemplary illustration of an under-display/in-display microlens or pinhole type biometric optical sensor. FIG. 4 shows a cross-sectional exemplary illustration of an under-display/in-display microlens or pinhole type biometric optical sensor in normal operation mode. Part of a fingertip is shown touching the top surface of a cover glass over an OLED display panel and with the biometric optical sensor below the OLED display panel. Normal mode operation is illustrated where display pixels below the finger are illuminating the finger. The illumination angle in FIG. 4 is substantially zero, i.e. the incidence angle of the illuminating light (aka probe light), is within the acceptance angle of the optical sensor, such that specular reflections are detected by the optical sensor. This is suitable for forming an image of the fingerprint because it is easy to distinguish between ridges and valleys due to the dominating reflection from air-glass interface in the valleys.

FIG. 5 corresponds to FIG. 4 with the difference that there is an Area 2 where the finger is illuminated by the display pixels directly below Area 2, and an adjacent Area 1 where the display pixels directly below Area 1 are turned off. The illumination angle in Area 2, i.e. the incidence angle of the illuminating light (aka probe light), is within the acceptance angle of the optical sensor, such that specular reflections from the illumination light incident on Area 2 are detected by the optical sensor. In Area 1 in FIG. the display pixels directly below are turned off and the part of the finger in Area 1 is only indirectly illuminated with light from the display pixels below Area 2. The illumination angle in Area 1 is therefore much larger and can exceed the acceptance angle of the optical sensor. Due to the larger incidence angle of the illumination light, the specular reflections from the illumination light in Area 1 are now outside the acceptance angle of the optical sensor. Thereby the dominating reflection from the air-glass interface can be removed from the detection and reflectance spectroscopy is possible, in particular from the ridges because they will carry most information about the material of the finger.

FIG. 6 shows a cross-sectional exemplary illustration of an under-display camera type biometric optical sensor. Part of a fingertip is shown touching the top surface of a cover glass over an OLED display panel. The biometric optical sensor is integrated in a camera setup below the OLED display panel, a single optical setup is viewing the entire sensing area. Thereby the acceptance angle of the camera type optical sensor depends on the viewing angle, as also illustrated in FIG. 6.

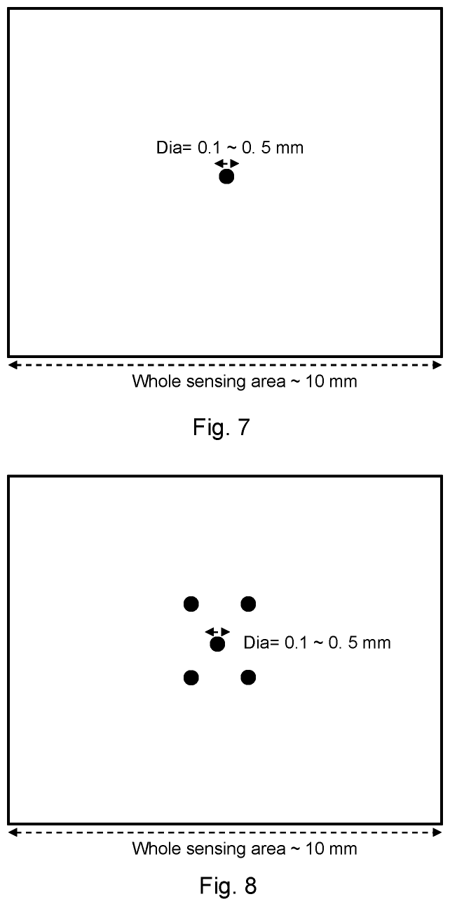

FIGS. 7-10 show different examples of illumination patterns for making reflectance spectroscopy possible in under-display and in-display biometric optical sensors. In FIGS. 7-10 the touch sensing area is shown as a rectangle with a side length on the order of 10 mm. In FIG. 7 a dark circle at the center of the OLED with a diameter of around 0.1-0.5 mm is provided to illustrate that the display pixels below this dark circle are turned off, and hence reflectance spectroscopy can be provided in this dark spot of the sensing area. The diameter of the dark circle can be optimized to the specific conditions, in particular in terms of the thickness of cover glass and the resolution of the optical sensor.

FIG. 8 shows five dark spots in the sensing area, each of the spots in FIG. 8 corresponds to the single spot in FIG. 7, i.e. reflectance spectroscopy can be provided in all five areas thereby most likely improving the spoof detection because the total area of the dark spots are increase and the location of the spots are more widely distributed. The diameter, the number and/or the locations of the dark circles can be optimized to the specific conditions, in particular in terms of the thickness of cover glass and the resolution of the optical sensor.

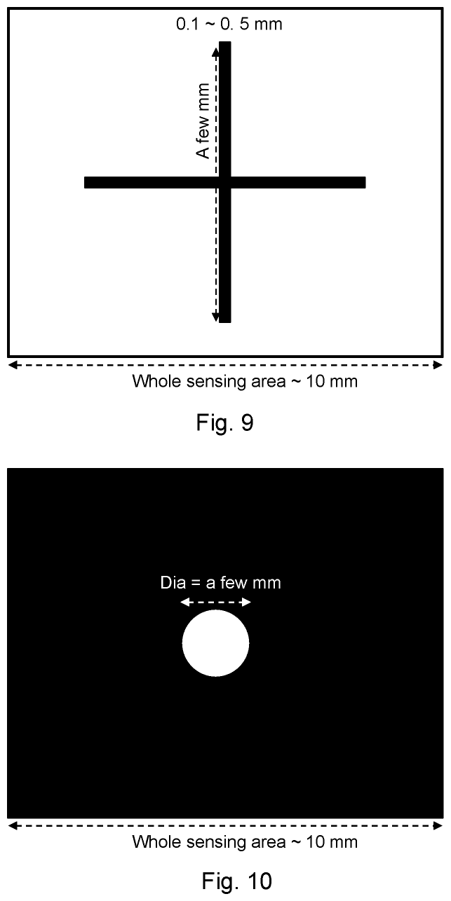

FIG. 9 shows an example of an illumination pattern illustrated as a dark cross in the sensing area, with the width of the stripes of the cross on the order of 0.1-0.5 mm and the length of the stripes on the order of a few mm. The example in FIG. 9 further increases the total dark area suitable for reflectance spectroscopy.

FIG. 10 shows an example of an illumination pattern illustrated as one central light spot with a diameter of a few millimeters in the central part of the sensing area; the total dark area is thereby significantly increased. The illumination pattern in FIG. 10 is most suitable for camera type optical sensors.

Increasing the dark area will in general improve the spoof detection because the reflectance spectroscopy intensity will naturally increase, however only to a certain limit because there still need to be some light from adjacent pixels for indirect illumination. One example of an illumination pattern for reflectance spectroscopy is periodic black and white stripes across the sensor frame, i.e. the dark area is increased due to a plurality of dark stripes but light from adjacent light stripes provides for the necessary indirect illumination.

The illumination pattern examples in FIG. 7-9 can be utilized for both single frame acquisition, and multi-frame acquisition. In single frame acquisition both the normal object image is acquired and reflectance spectroscopy is provided from the same single sensor frame, such that there is only one predefined illumination pattern, i.e. the first illumination pattern is the same as the second illumination pattern. Acquiring normal mode object imaging and reflectance spectroscopy/spoof detection in the same frame also depends on the quality of the object image itself. The under-display biometric sensor disclosed in pending application PCT/EP2019/061738 is an example of an optical sensor providing very high image quality. In multi-frame acquisition, e.g. acquisition in two different frames, the first and second illumination patterns will typically be different, wherein the first illumination pattern can be designed to optimize reflectance spectroscopy and the second illumination pattern can be design to optimize normal mode operation.

### Example Thresholds

As mentioned above a reference for distinguishing live tissue from fake samples can be provided by defining intensity ratio thresholds, e.g. the intensity ratio thresholds relative to one of the colors red, green and blue of RGB light emitting pixels.

Typical OLED RGB light emitting pixels has the following wavelengths:

| | |
|---|---|
| Red | 630 nm ± 20 nm |
| Green | 530 nm ± 20 nm |
| Blue | 460 nm ± 10 nm |

Three different live tissue fingertips were measured employing reflectance spectroscopy as disclosed herein to provide the reflected intensity at each color avoiding the specular reflections. The intensity ratio values are shown in Table 1, and they have been normalized with the value at red light as the reference of 1.

TABLE 1

| Reflectance | Red | Green | Blue |
|---|---|---|---|
| Sample 1 | 1.00 | 0.82 | 0.56 |
| Sample 2 | 1.00 | 0.72 | 0.52 |
| Sample 3 | 1.00 | 0.77 | 0.60 |

From Table 1 a threshold range can be defined range to verify a live tissue fingertip:

| | |
|---|---|
| Green | 0.70-0.85 |
| Blue | 0.50-0.65 |

Hence, a fingerprint can be validated if the intensity ratio thresholds of both the green and blue colors (relative to red) are within these intervals.

Three different silicone fingertips (i.e. fake fingerprints) were measured employing reflectance spectroscopy as disclosed herein to provide the reflected intensity at each color avoiding the specular reflections. The intensity ratio values are shown in Table 2, and they have been normalized with the value at red light as the reference of 1.

TABLE 2

| Reflectance | Red | Green | Blue |
|---|---|---|---|
| Fake 1 | 1.00 | 0.43 | 0.14 |
| Fake 2 | 1.00 | 0.78 | 0.43 |
| Fake 3 | 1.00 | 0.54 | 0.39 |

As seen from Table 2, all the tested silicone samples could be caught in the presently disclosed spoof detection. For the green colour two out of three intensity ratio thresholds were outside the validation range, whereas for the blue colour all intensity ratio thresholds were outside the validation range.

Further Details of Present Disclosure
1. An electronic device for detecting and validating an object by optical sensing, comprising
   a display panel having pixels to display images,
   a top transparent surface formed over the display panel as an interface for being touched by a user for touch sensing operations,
   an optical sensor module located under the display panel or integrated in the display panel comprising
      a sensor array of optical detector pixels configured for
   a) receiving light reflected from the object on the surface of the display panel, and
   b) generating image data according to the received light, wherein the electronic device, during touch sensing operation, is configured to:
      controlling pixels of the display panel to provide light in a predefined first illumination pattern towards the object on the surface of the display panel,
      directing light reflected from the object on the surface of the display panel to the sensor array within a predefined acceptance angle,
      acquiring, with the sensor array, first image data, based on or of, light reflected from a first part of the object which is only illuminated with light from the predefined first illumination pattern from which the specular reflections by the surface of the display panel is outside the predefined acceptance angle, and
      analysing intensities at different wavelengths in said first image data to validate the object.
2. The electronic device according to item 1, wherein the predefined acceptance angle is 20 degrees or 10 degrees or 5 degrees or 3 degrees.
3. The electronic device according to any of the preceding items, configured for:
   controlling pixels of the display panel to provide light in a predefined second illumination pattern towards the object on the surface of the display panel,
   acquiring, with the sensor array, second image data based on light reflected from a second part the object which is illuminated with light from the predefined second illumination pattern, and
   acquiring, with the sensor array, second image data comprising light reflected from the second part of the object, and
   analysing the second image data to form an image of the object.
4. The electronic device according to any of the preceding items, wherein the first image data and/or the second image data corresponds to a predefined and/or fixed subset of the sensor array.
5. The electronic device according to any of the preceding items, wherein the intensity at one wavelength in said first image data corresponds to processing all pixel values of a subset of the sensor array, processing such as averaging, integrating, and/or adding.
6. The electronic device according to any of the preceding items, further configured for background intensity calibration by:
   acquiring, with the sensor array, background image data corresponding to the first image data based on light reflected from only the surface (without an object on the surface) of the display panel, and received within said predefined acceptance angle, and
   analysing intensities at said different wavelengths to determine a background intensity at each of said different wavelengths.
7. The electronic device according to item 6, configured for performing background intensity calibration during registration of a new object.
8. The electronic device according to any of the preceding items, wherein the object is validated by analysing the intensity variation (relative to a background intensity) as a function of the wavelength of the light and comparing it to a reference.
9. The electronic device according to any of the preceding items 8, wherein the reference is a reflectance spectral variation.
10. The electronic device according to any of the preceding items 8, wherein the reference is one or more thresholds, such as one or more intensity ratio thresholds, such as one or more thresholds defining whether or not the object is live tissue.
11. The electronic device according to any of the preceding items 8-10, wherein the reference is obtained from objects of the same kind.
12. The electronic device according to any of the preceding items 8-11, further configured for obtaining a reference for a specific object during registration of said by: analysing intensities at said different wavelengths to determine a reference intensity variation for said specific object.
13. The electronic device according to any of the preceding items, wherein the predefined first and/or second illumination pattern is a predefined time-varying illumination pattern, such that the illuminated first and second parts of the object optionally is identical or at least partly overlapping.
14. The electronic device according to any of the preceding items, wherein the predefined first and/or second illumination pattern corresponds to activation of one or more predefined subsets of the pixels of the display panel.
15. The electronic device according to any of the preceding items, wherein the location and configuration of a predefined and/or fixed (active) subset of the sensor array may accordingly be related to and/or defined by the predefined first and/or second illumination pattern.
16. The electronic device according to any of the preceding items, wherein the predefined first and/or second illumination pattern is a predefined spatial illumination pattern.
17. The electronic device according to any of the preceding items, wherein the predefined first and/or second illumination pattern is a predefined color varying illumination pattern.
18. The electronic device according to any of the preceding items, wherein the predefined first and second illumination patterns are emitted concurrently such that the first and second image data can be acquired concurrently.
19. The electronic device according to any of the preceding items, wherein the pixels of the display panel are RGB light emitting pixels, and wherein the electronic device, during touch sensing operation, is configured to controlling RGB light emitting pixels of the display panel to emit RGB light in the predefined first and/or second illumination pattern.
20. The electronic device according to any of the preceding items, wherein the display panel is selected from the group of: Electroluminescent (ELD) display, Liquid crystal display (LCD), Light-emitting diode (LED) display, such as OLED or AMOLED, Plasma (PDP) display, and Quantum dot (QLED) display.
21. The electronic device according to any of the preceding items, further configured for controlling at least one probe light source, such as an LED or laser, separate from the display panel to provide probe light to illuminate the object on the surface of the display panel, such that the light from the probe light source becomes part of the predefined first and/or second illumination pattern.
22. The electronic device according to any of the preceding items, comprising at least two probe light sources, such as LEDs or lasers, separate from the display panel, the probe light sources having at least two different wavelengths, and wherein the electronic device is configured such that the pixels of the display panel control light emittance of said probe light sources to illuminate the object on the surface of the display panel, such that the light from the probe light sources become at least part of the predefined first and/or second illumination patterns.
23. The electronic device according to any of the preceding items 21-22, wherein the light from the probe light source(s) comprises at least one color which is different from light from the display panel, such as infrared light.
24. The electronic device according to any of the preceding items 21-23, wherein light from at least a first probe light source is of a color which is less than light from the display panel, wherein light from at least a second probe light source is of a color which is larger than light from the display panel.
25. The electronic device according to any of the preceding items 21-24, wherein the at least one probe light source is part of the optical sensor module.
26. The electronic device according to any of the preceding items, wherein the optical detector pixels of the sensor array are chromatic pixels for distinguishing different colors of the received light.
27. An image recognition device, such as a fingerprint detector, comprising a optical sensor module according to any of preceding items, a storage unit for storing image information and a processing unit for processing the signal from the sensor array in order to recognize an image.

1. An electronic device for detecting and validating an object by optical sensing, comprising
a display panel having pixels to display images,
a top transparent surface formed over the display panel as an interface for being touched by a user for touch sensing operations,
an optical sensor module located under the display panel or integrated in the display panel comprising
a sensor array of optical detector pixels configured for
a) receiving light reflected from the object on the surface of the display panel, and
b) generating image data according to the received light,
wherein the electronic device, during touch sensing operation, is configured to:
controlling pixels of the display panel to provide light in a predefined first illumination pattern towards the object on the surface of the display panel,
directing light reflected from the object on the surface of the display panel to the sensor array within a predefined acceptance angle,
acquiring, with the sensor array, first image data of light reflected from a first part of the object which is only illuminated with light from the predefined first illumination pattern from which the specular reflections by the surface of the display panel is outside the predefined acceptance angle, and
analysing intensities at different wavelengths in said first image data to validate the object.

2. The electronic device according to claim 1, configured for:
controlling pixels of the display panel to provide light in a predefined second illumination pattern towards the object on the surface of the display panel,
acquiring, with the sensor array, second image data based on light reflected from a second part the object which is illuminated with light from the predefined second illumination pattern, and
acquiring, with the sensor array, second image data comprising light reflected from the second part of the object, and
analysing the second image data to form an image of the object.

3. The electronic device according to any of the preceding claims, wherein the acceptance angle of the sensor array and the positioning of the optical detector pixels with respect to the top transparent surface, is such that the optical detector pixels receive light reflected from areas of the top transparent surface that do not overlap.

4. The electronic device according to any of the preceding claims, wherein the first image data and/or the second image data corresponds to a predefined and/or fixed subset of the sensor array.

5. The electronic device according to any of the preceding claims, wherein the intensity at one wavelength in said first image data corresponds to processing all pixel values of a subset of the sensor array, processing such as averaging, integrating, and/or adding.

6. The electronic device according to any of the preceding claims, wherein the object is validated by analysing the intensity variation (relative to a background intensity) as a function of the wavelength of the light and comparing it to a reference.

7. The electronic device according to any of the preceding claim 6, wherein the reference is selected from the group of: a reflectance spectral variation, one or more thresholds, one or more intensity ratio thresholds, and one or more thresholds defining whether or not the object is live tissue.

8. The electronic device according to any of the preceding claims 6-7, further configured for obtaining a reference for a specific object during registration of said by: analysing intensities at said different wavelengths to determine a reference intensity variation for said specific object.

9. The electronic device according to any of the preceding claims, wherein the predefined first and/or second illumination pattern is a predefined time-varying illumination pattern, such that the illuminated first and second parts of the object optionally is identical or at least partly overlapping.

10. The electronic device according to any of the preceding claims, wherein the predefined first and/or second illumination pattern corresponds to activation of one or more predefined subsets of the pixels of the display panel such as wherein the predefined first and/or second illumination pattern is a predefined spatial illumination pattern.

11. The electronic device according to any of the preceding claims, wherein the location and configuration of a predefined and/or fixed (active) subset of the sensor array is related to and/or defined by the predefined first and/or second illumination pattern.

12. The electronic device according to any of the preceding claims, wherein the predefined first and second illumination patterns are emitted concurrently such as to allow that the first and second image data can be acquired concurrently.

13. The electronic device according to any of the preceding claims, wherein the pixels of the display panel are RGB light emitting pixels, and wherein the electronic device, during touch sensing operation, is configured for controlling RGB light emitting pixels of the display panel to emit RGB light in the predefined first and/or second illumination pattern.

14. The electronic device according to any of the preceding claims, further configured for controlling at least one probe light source, such as an LED or laser, separate from the display panel to provide probe light to illuminate the object on the surface of the display panel, such as wherein the light from the probe light source becomes part of the predefined first and/or second illumination pattern.

15. The electronic device according to any of the preceding claims, comprising at least two probe light sources, such as LEDs or lasers, separate from the display panel, the probe light sources having at least two different wavelengths, and wherein the pixels of the display panel control light emittance of said probe light sources to illuminate the object on the surface of the display panel, such as wherein the light from the probe light sources become at least part of the predefined first and/or second illumination patterns.

16. The electronic device according to any of the preceding claims 14-15, wherein the at least one or two probe light sources is part of the optical sensor module.

17. The electronic device according to any of the preceding claims, wherein the display panel is selected from the group of: Electroluminescent (ELD) display, Liquid crystal display (LCD), Light-emitting diode (LED) display, such as OLED or AMOLED, Plasma (PDP) display, and Quantum dot (QLED) display.

18. The electronic device according to any of the preceding claims 15-17, wherein the light from the probe light source(s) comprises at least one color which is different from light from the display panel, such as infrared light.

19. The electronic device according to any of the preceding claims 15-18, wherein light from at least a first probe light source is of a color which is less than light from the display panel, wherein light from at least a second probe light source is of a color which is larger than light from the display panel.

20. The electronic device according to any of the preceding claims 15-19, wherein the at least one probe light source is part of the optical sensor module.

21. The electronic device according to any of the preceding claims, wherein the optical detector pixels of the sensor array are chromatic pixels for distinguishing different colors of the received light.

22. An image recognition device, such as a fingerprint detector, comprising an optical sensor module according to any of preceding claims, a storage unit for storing image information and a processing unit for processing the signal from the sensor array in order to recognize an image.
